(19) United States
(12) Patent Application Publication
(10) Pub. No.: US 2016/0366942 A1
(43) Pub. Date: Dec. 22, 2016

(54) BATTERY STICK AND ELECTRONIC CIGARETTE HAVING SAME

(71) Applicant: KIMREE HI-TECH INC., Tortola (VG)

(72) Inventor: Qiuming Liu, Shenzhen, Guangdong (CN)

(21) Appl. No.: 15/122,258

(22) PCT Filed: Feb. 28, 2014
(86) PCT No.: PCT/CN2014/072730

§ 371 Date: Aug. 29, 2016

(51) Int. Cl. A24F 47/00; H01M 2/34

(52) U.S. Cl. CPC A24F 47/008; H01M 2/34; H01M 2220/30

(57) ABSTRACT

The invention relates to a battery stick and an electronic cigarette having same. The battery stick includes an outer electrode, an inner electrode that is defined through the outer electrode and is electrically insulated from the outer electrode, and a battery that is electrically connected to the outer electrode. The battery stick further includes an insulating part arranged between the inner electrode and the battery and used for isolating the inner electrode from the battery. By means of arranging an insulating element between the inner electrode and the battery, the battery stick prevents the occurrence of a short circuit between the battery electrode and the inner electrode.

### TECHNICAL FIELD

The present invention relates to an electronic commodity, and more particularly relates to a battery stick and an electronic cigarette having same.

### BACKGROUND

An electronic cigarette is a common electronic product to simulate a cigarette. The electronic cigarette mainly comprises an atomizer and a battery stick. The battery stick supplies power for the atomizer to make the atomization component in the atomizer heat to vaporize the oil in the atomizer to emit smoke to simulate the cigarette.

As shown in FIG. 1, the battery stick in the prior art comprises a battery sleeve 01, an electrode component inserted in an end of the battery sleeve 01, a battery 04 which is accommodated in the battery sleeve 01 and is electrically connected to the electrode component, an end cover 02 which covers the other end of the battery sleeve 01, and a controller 03 which is accommodated in the battery sleeve 01 and is between the battery 04 and the end cover 02. The controller 03 and the battery 04 are electrically connected by wires. An electrode component comprises an outer electrode 08 which is inserted in the battery sleeve 01, an inner electrode 05 which is electrically insulated with the outer electrode 08, a fixed support 06 which is inserted in the outer electrode 08 and is used for fixing the inner electrode 05, and an insulation ring 07 which is arranged between the fixed support 06 and the inner electrode 05. The insulation ring 07 is used for electrically insulating the inner electrode 05 from the outer electrode 08. The outer electrode 08 is electrically connected to the battery 04 by wires. The inner electrode 05 is electrically connected to the controller 03 by wires and is defined in an interval from the battery 04. However, as shown in FIG. 1, as the battery 04 is near the inner electrode 05, it is easy to cause a problem of a short circuit to influence the performance of the electronic cigarette.

### SUMMARY

Based on the above-mentioned drawbacks, the present invention provides a battery stick that can prevent the short circuit problem between battery electrodes and the inner electrode, and an electronic cigarette having same.

The present invention provides a battery stick, the battery stick is used for assembling an electronic cigarette with an atomizer, the battery stick comprises an outer electrode, an inner electrode which is through the outer electrode and is electronically insulated with the outer electrode, and a battery electronically connected to the outer electrode, wherein, the battery stick further comprises an insulation part which is arranged between the inner electrode and the battery and is used for isolating the inner electrode with the battery.

In the battery stick provided in the present invention, the battery stick further comprises a fixed support which is inserted in the outer electrode and is used for fixing the inner electrode, an end of the insulation part is connected to the fixed support, the other end of the insulation part extends between the inner electrode and the battery.

In the battery stick provided in the present invention, the fixed support comprises an inserting part connected to the outer electrode and an extending part which is formed by extending from an end face of the inserting part toward the battery; a through hole is formed in the inserting part and is used for being inserted by the inner electrode; the extending part is used for forming an interval between the inner electrode and the battery.

In the battery stick provided in the present invention, the insulation part comprises a connecting part connected to the fixed support and an obstructing part which is formed by extending from an end of the connecting part toward the inner electrode, the obstructing part extends between the inner electrode and the battery.

In the battery stick provided in the present invention, the connecting part and the fixed support are movably connected, the way of the movable connection comprises the pivot connection or the hinged connection.

In the battery stick provided in the present invention, the insulation part and the fixed support are integrated, the thickness of a joint of the connecting part and the fixed support is smaller than the thickness of the connecting part.

In the battery stick provided in the present invention, the joint of the connecting part and the obstructing part is provided with an avoiding groove, an end of the avoiding groove near the obstructing part is provided with a fastener, the fastener is used for fastening with the fixed support

In the battery stick provided in the present invention, the fastener is a bulge extruded along a side of the obstructing part near the fixed support toward the fixed support.

In the battery stick provided in the present invention, the longitudinal section of the bulge is semicircular.

In the battery stick provided in the present invention, the longitudinal section of the bulge is trapezoid.

In the battery stick provided in the present invention, the insulation part comprises an isolating part which is connected to the extending part and is used for isolating the inner electrode with the battery.

In the battery stick provided in the present invention, the isolating part comprises a first isolating part and a second isolating part which are vertically connected, the first isolating part is connected to the extending part, the second isolating part is abutted against an end face of the inserting part.

In the battery stick provided in the present invention, the first isolating part and the extending part are movably connected by an elastic piece.

The present invention further provides a battery stick, the battery stick is used for assembling an electronic cigarette with an atomizer, wherein, the battery stick comprises an outer electrode, an inner electrode which is through the outer electrode and is electronically insulated with the outer electrode, a battery connected to the outer electrode, and an insulation part which is arranged between the inner electrode and the battery and is used for isolating the inner electrode with the battery;

The insulation part comprises a connecting part connected to the fixed support and an obstructing part which is formed by extending from an end of the connecting part toward the inner electrode, the obstructing part extends between the inner electrode and the battery;

The insulation part and the fixed support are integrated, the thickness of a joint of the connecting part and the fixed support is smaller than the thickness of the connecting part, the fixed support is folded around the joint.

The present invention further provides an electronic cigarette, the electronic cigarette comprises an atomizer, wherein, the electronic cigarette further comprises the battery stick in the claim 1.

The beneficial effects of implementing the battery stick and the electronic cigarette having same of the present invention are:

The battery stick of the present invention can effectively prevent the short circuit problem between the battery electrode and the inner electrode by arranging an insulation part between the battery electrode and the inner electrode.

Further, as the insulation part and the fixed support are integrated, there is no need for additional components. Thus, the processing cost can be reduced. It is convenient to assemble and manage to save processing time and management cost.

Further, the insulation part and the fixed support are movably connected. The fastener is arranged on the insulation part. The insulation part is fixed on the fixed support by the fastener. Thus, it is easy to assemble to improve the production efficiency.

### BRIEF DESCRIPTION OF THE DRAWINGS

The invention will be further described with reference to the accompanying drawings and embodiments in the following.

FIG. 1 is a structure schematic diagram of a battery stick in prior art;

FIG. 2 is a structure schematic diagram of the battery stick of a better embodiment of the present invention;

FIG. 3 is an exploded view of the battery stick of a better embodiment of the present invention;

FIG. 4 is a structure schematic diagram of the insulation part of the electrode component in FIG. 2 before folding;

FIG. 5 is a structure schematic diagram of the insulation part of the electrode component in FIG. 2 after folding;

FIG. 6 is a structure schematic diagram of the insulation part of the electrode component in the other embodiment of the present invention before folding;

FIG. 7 is a structure schematic diagram of the insulation part of the electrode component in the other embodiment of the present invention after folding.

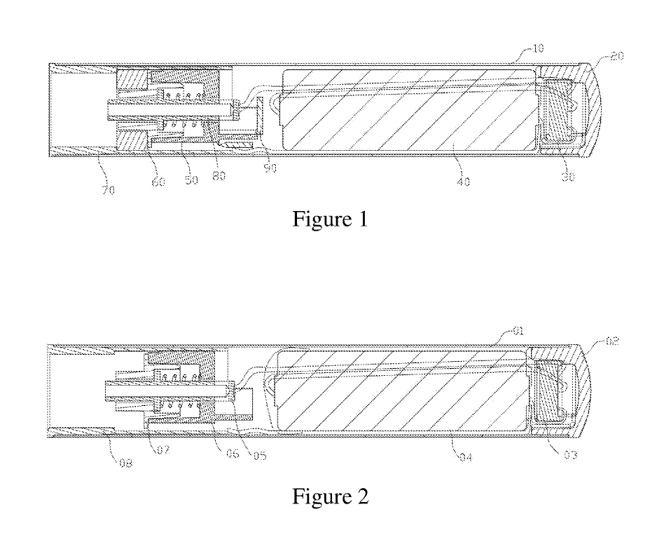

### DETAILED DESCRIPTION OF THE PREFERRED EMBODIMENT

The battery stick of the present invention can effectively prevent the short circuit problem between the battery electrodes and the inner electrode by arranging an insulation part between the battery and the inner electrode. The insulation part and the fixed support can be integrated, then there is no need for additional components. Thus, processing costs can be reduced and it is convenient to assemble and manage to save processing time and management costs as well. In the present invention, the insulation part and the fixed support are movably connected and can be folded. The fastener is arranged on the insulation part. The insulation part is fixed on the fixed support by the fastener. Thus, it is easy to assemble to improve the production efficiency.

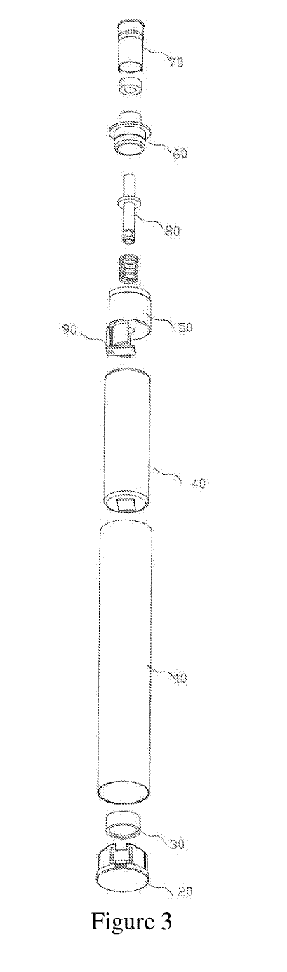

As shown in FIG. 2 and FIG. 3, which are structure schematic diagrams of the battery stick of a preferred embodiment of the present invention. In this embodiment, the battery stick comprises a battery sleeve 10, a battery 40 which is accommodated in the battery sleeve 10, an electrode component (not labeled) which is inserted in an end of the battery sleeve 10, an end cover 20 which covers on the other end of the battery sleeve 10, and a controller 30 which is accommodated in the battery sleeve 10 and is between the battery 40 and the end cover 20. The electrode component comprises an outer electrode 70 inserted in the battery sleeve 10, an inner electrode 80 which is inserted in the outer electrode 70 and is electronically insulated with the outer electrode 70, a fixed support 50 which is inserted between the outer electrode 70 and the inner electrode 80 and is used for fixing the inner electrode 80, and an insulation ring 60 which is arranged between the fixed support 50 and the inner electrode 80 and is used for insulating the outer electrode 70 from the inner electrode 80. The cathode of the battery 40 is electrically connected to the outer electrode 70 by wires. The anode of the battery 40 is electrically connected to the controller 30 by wires. The controller 30 is electrically connected to the inner electrode 80 by wires. There is an interval between the inner electrode 80 and the battery 40. In this embodiment, an insulation part 90 is arranged between the inner electrode 80 and the battery 40 to effectively prevent the short circuit problem.

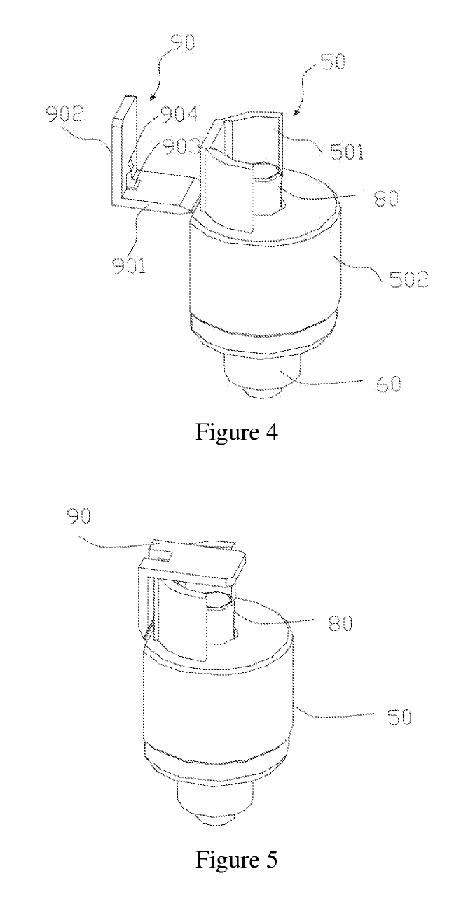

Specifically, as shown in FIG. 4 and FIG. 5 with referring to FIG. 3, the fixed support 50 which is provided in the preferred embodiment of the present invention presents a cylindrical structure with an end opening and the other end closing. The fixed support 50 comprises an inserting part 502 connected to the outer electrode 70 and an extending part 501 which is formed by extending from an end surface of the close end of the inserting part 502 toward the battery 40. A through hole is formed in the inserting part 502 and is used for being inserted by the inner electrode 80. The inner electrode 80 is inserted in the through hole and extends out toward a side of the battery 40. The extending part 501 is used for covering a part outside the through hole of the inner electrode 80. The cross section of the extending part 501 presents an arc bulge. A radian of the extending part 501 can be same as a radian of the inserting part 502, so a manufacturing process of the extending part 501 is easy and the processing costs can be saved. The extending part 501 is used for forming an interval between the inner electrode 80 and the battery 40. The insulation ring 60 is arranged on an exterior of the inner electrode 80 and covers the opening end of the fixed support 50. Thus the inner electrode 80 can be mounted more securely.

In order to prevent a short circuit between the inner electrode 80 and the battery 40, an insulation part 90 is arranged between the inner electrode 80 and the battery 40. Specifically, an end of the insulation part 90 is connected to the fixed support 50, the other end of the insulation part 90 extends between the inner electrode 80 and the battery 40 to isolate the inner electrode 80 from the battery 40.

In an embodiment of the present invention, the insulation part 90 presents a L-shape. The insulation part 90 comprises a connecting part 901 connected to the fixed support 50 and an obstructing part 902 which is formed by bending and extending from an end of the connecting part 901 toward a side of the inner electrode 80, the obstructing part 902 extends between the inner electrode 80 and the battery 40. In this embodiment, the insulation part 90 and the fixed support 50 are integrated, there is no need for additional components. Thus, the processing costs can be reduced, and it is convenient to assemble and manage to save processing time and management costs as well. The connecting part 901 of the insulation part 90 is connected to an edge of an end of the inserting part 502 of the fixed support 50. The connecting part 901 and an extending direction of the extending part 50 are parallel. The height of the connecting part 901 is higher than the height of the extending part 501. The obstructing part 902 extends along a direction which is vertical to the connecting part 901 to an outer side of the inner electrode 80. Thus the inner electrode 80 and the battery 40 can be isolated.

In this embodiment, a thickness of the joint of the connecting part 901 and the edge of the end of the fixed support 50 is smaller than a thickness of the connecting part 901 and the inserting part 502. Thus the connecting part 901 can be folded around the joint. The insulation part 90 that can be folded can make the insulation part 90 more flexible to be better matched with the fixed support 50, a structure of the whole insulation part 90 can be applied wider. It can be understood that, in other embodiments, the connection part 901 and the inserting part 502 of the fixed support 50 can be movably connected by a pivot connection or a hinged connection. In this embodiment, when the insulation part 90 is needed to be used, the insulation part 90 can be folded to a location between the inner electrode 80 and the battery 40 to isolate them.

In order to stably place the insulation part 90 after being folded between the inner electrode 80 and the battery 40, a fastener 904 is arranged on the insulation part 90. The insulation part 90 is fixed on the fixed support 50 by the fastener 904. Specifically, as shown in FIG. 4, a joint of the connecting part 901 of the insulation part 90 and the obstructing part 902 is provided with an avoiding groove 903 which is a strip. The purpose of arranging the avoiding groove 903 is to better connect the fixed support 50 of the insulation part 90 to extending part 501. The avoiding groove 903 extends from the connecting part 901 to the obstructing part 902. An end of the avoiding groove 903 where the obstructing part 902 locates is provided with the fastener 904 which is used for fastening the fixed support 50. The fastener 904 is a bulge which is formed by extruding along a side of the obstructing part 902 near the fixed support 50 toward the fixed support 50. The longitudinal section of the bulge can be a semicircular or a trapezoid. In this embodiment, the fastener 904 is fastened with a groove of an edge of the extending part 501 of the fixed support 50. So the insulation part 90 that can be folded is fixed on the fixed support 50. The insulation part 90 is fixed on the fixed support 50 by the fastener 904. It is easy to assemble and a production efficiency can be improved.

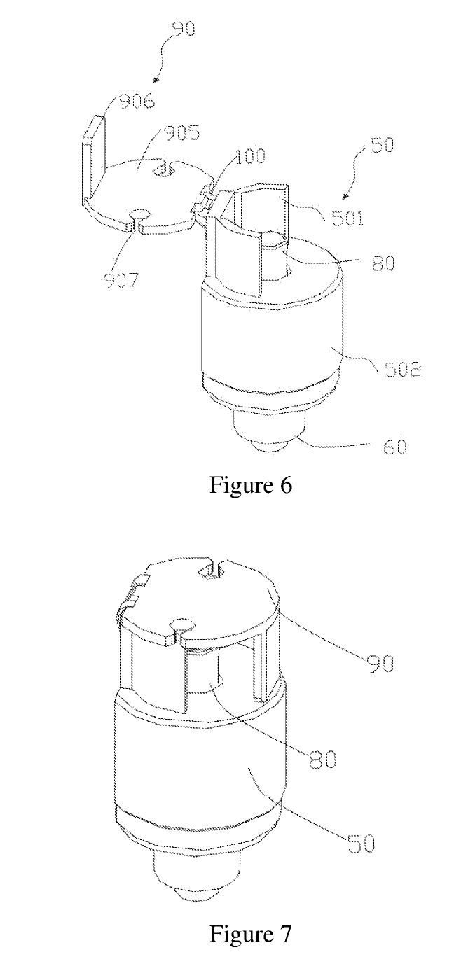

The electrode component provided in the other embodiment of the present invention is shown in FIG. 6 and FIG. 7. The only difference of the electrode component provided in this embodiment with the electrode component provided in the previous embodiment is the structure of the insulation part 90. In this embodiment, the insulation part 90 comprises an isolating part (not labeled) which is connected to an edge of an end of the extending part 501 which is along an axial direction of the extending part 501, the isolating part is used for isolating the inner electrode 80 from the battery 40. In this embodiment, the insulation part 90 comprises a first isolating part 905 which covers the inner electrode 80 and presents a disc shape, and a second isolating part 906 which is perpendicularly connected to the first isolating part 905. The second isolating part 906 is form by extending from an edge of the isolating part 905 towards a side of the fixed support 50, an end of the second isolating part 906 abuts against a surface of the close end of the inserting part 502. Thus, the first isolating part 905, the second isolating part 906 and the extending part 501 surround a close space which is used for accommodating a part of the inner electrode 80 which extends outside the through hole, then the inner electrode 80 and the battery 40 are completely isolated. In order to realize an electrical connection of the controller 30 and the inner electrode 80 by wires connection, a breach 907 is arranged at the first isolating part 905. The breach is used for being through by wires to connect the inner electrode 80.

In this embodiment, in order to make the insulation part 90 and the fixed support 50 movably connected, an elastic piece 100 is defined to realize a connection between the insulation part 90 and the fixed support 50. An end of the elastic piece 100 is connected to the first isolating part 905, the other end of the elastic piece 100 is connected to the extending part 501, so the insulation part 90 can be folded around the elastic piece 100 and a force required for folding is not large. Thus, the insulation part 90 that can be folded can make the insulation part 90 more flexible and be better matched with the fixed support 50. The structure of the whole insulation part 90 can be applied wider. In order to increase the stability of the folding, a pair of elastic pieces 100 are connected between the first isolating part 905 and the extending part 501 in this embodiment.

The battery stick provided in the present invention can effectively prevent the short circuit problem between the battery electrodes and the inner electrode by arranging an insulation part between the battery and the inner electrode. Further, the insulation part can be folded to make it more flexible and can be better matched with the fixed support, then the assembly of the electronic cigarette is more convenient.

The present invention further provides an electronic cigarette. The electronic cigarette comprises an atomizer and an above-mentioned battery stick connected to the atomizer. The electronic cigarette provided in the present invention can effectively prevent the short circuit problem between the battery electrode and the inner electrode.

It should be understood that, in the inspiration of the present invention, those skilled in the art who appreciate and realize all or part of the process in above embodiments may make many modifications or alternatives, without going beyond the purpose and the scope the claims intend to protect of the present application. All these belong to the protection of the present invention.

What claimed is:

1. A battery stick, used for assembling an electronic cigarette with an atomizer, the battery stick comprises an outer electrode (70), an inner electrode (80) which is defined through the outer electrode (70) and is electronically insulated from the outer electrode (70), and a battery (40) which is electronically connected to the outer electrode (70), wherein, the battery stick further comprises an insulation part (90) which is arranged between the inner electrode (80) and the battery (40) and is used for isolating the inner electrode (80) from the battery (40).

2. The battery stick according to claim 1, wherein, the battery stick further comprises a fixed support (50) which is inserted in the outer electrode (70) and is used for fixing the inner electrode (80), an end of the insulation part (90) is connected to the fixed support (50), the other end of the insulation part (90) extends to a position which is between the inner electrode (80) and the battery (40).

3. The battery stick according to claim 2, wherein, the fixed support (50) comprises an inserting part (502) connected to the outer electrode (70) and an extending part (501) which is formed by extending from an end surface of the inserting part (502) toward the battery (40); a through hole is formed in the inserting part (502) and is used for being inserted by the inner electrode (80); the extending part (501) is used for forming an interval between the inner electrode (80) and the battery (40).

4. The battery stick according to claim 3, wherein, the insulation part (90) comprises a connecting part (901) connected to the fixed support (50) and an obstructing part (902) which is formed by bending and extending from an end of the connecting part (901) toward the inner electrode (80), the obstructing part (902) extends to a position which is between the inner electrode (80) and the battery (40).

5. The battery stick according to claim 4, wherein, the connecting part (901) and the fixed support (50) are movably connected, modes of a movable connection comprises a pivot connection or a hinged connection.

6. The battery stick according to claim 4, wherein, the insulation part (90) and the fixed support (50) are integrated, a thickness of a joint of the connecting part (901) and the fixed support (50) is smaller a thickness of the connecting part (901).

7. The battery stick according to claim 6, wherein, a joint of the connecting part (901) and the obstructing part (902) is provided with an avoiding groove (903), an end of the avoiding groove (903) near the obstructing part (902) is provided with a fastener (904), the fastener (904) is used for fastening with the fixed support (50).

8. The battery stick according to claim 7, wherein, the fastener (904) is a bulge extruded along a side of the obstructing part (902) near the fixed support (50) toward the fixed support (50).

9. The battery stick according to claim 8, wherein, a longitudinal section of the bulge is semicircular.

10. The battery stick according to claim 8, wherein, a longitudinal section of the bulge is trapezoid.

11. The battery stick according to claim 3, wherein, the insulation part (90) comprises an isolating part which is connected to the extending part (501) and is used for isolating the inner electrode (80) from the battery (40).

12. The battery stick according to claim 11, wherein, the isolating part comprises a first isolating part (905) and a second isolating part (906) which are perpendicularly connected to each other, the first isolating part (905) is connected to the extending part (501), the second isolating part (906) is abutted against an end surface of the inserting part (502).

13. The battery stick according to claim 12, wherein, the first isolating part (905) and the extending part (501) are movably connected to each other via an elastic piece (100).

14. A battery stick, used for assembling an electronic cigarette with an atomizer, wherein, the battery stick comprises an outer electrode (70), an inner electrode (80) which is defined through the outer electrode (70) and is electronically insulated from the outer electrode (70), a battery (40) which is connected to the outer electrode (70), and an insulation part (90) which is arranged between the inner electrode (80) and the battery (40) and is used for isolating the inner electrode (80) from the battery (40);
the insulation part (90) and a fixed support (50) are integrated, a thickness of a joint of a connecting part (901) and the fixed support (50) is smaller than a thickness of the connecting part (901), the fixed support (50) is folded around the joint;
the insulation part (90) comprises the connecting part (901) which is connected to the fixed support (50) and an obstructing part (902) which is formed by bending and extending from an end of the connecting part (901) toward the inner electrode (80), the obstructing part (902) extends to a position which is between the inner electrode (80) and the battery (40).

15. An electronic cigarette, comprising an atomizer, wherein, the electronic cigarette further comprises the battery stick in the claim 1.
